(19) United States
(12) Patent Application Publication
(10) Pub. No.: US 2023/0368698 A1
(43) Pub. Date: Nov. 16, 2023

(54) Auto Bot Driver Training System, Vehicle, and Method of Use

(71) Applicants: Marquita James, Forrest City, AR (US); Rayshun Dorris, Forrest City, AR (US)

(72) Inventors: Marquita James, Forrest City, AR (US); Rayshun Dorris, Forrest City, AR (US)

(21) Appl. No.: 18/314,229

(22) Filed: May 9, 2023

Related U.S. Application Data
(60) Provisional application No. 63/340,028, filed on May 10, 2022.

(51) Int. Cl. G09B 19/16; G09B 5/06; B60W 60/00; B60W 50/14

(52) U.S. Cl. CPC G09B 19/167; G09B 5/06; B60W 60/001; B60W 50/14; B60W 2420/40; B60W 2050/146; B60W 2556/45

(57) ABSTRACT

A multifunctional auto bot driving test vehicle system integrated in a vehicle comprising an auto bot driving test processor, a display screen, a plurality of cameras, one or more speakers, and a wireless channel established between a remote handheld device and a wireless transceiver of the ABDT system for pairing and communicating. The system is also configured to control brakes, steering, movement, and other functionalities of the vehicle by sending instructions to the Electronic Control Unit (ECU) of the vehicle. The processor is coupled to the ECU through a Controller Area Network (CAN) enabling the processor to send and receive signals from the ECU. The system is designed to provide a safer and more efficient way for new drivers to learn how to drive, as well as provide a way for remote users to monitor the vehicle and provide feedback on areas for improvement.

### CROSS-REFERENCE TO RELATED APPLICATION

The present application claims priority to, and the benefit of, U.S. Provisional Application No. 63/340,028, which was filed on May 10, 2022, and is incorporated herein by reference in its entirety.

### FIELD OF THE INVENTION

The present invention generally relates to the field of driver training systems. More specifically, the present invention relates to a novel multifunctional training automobile and system for new drivers. The system provides different types of safety tasks and includes cameras, speakers, a display device, and a processor. The vehicle and the system can be controlled by a remote user using a mobile application installed in a user device paired with the system. Accordingly, the present disclosure makes specific reference thereto. Nonetheless, it is to be appreciated that aspects of the present invention are also equally applicable to other like applications, devices, and methods of manufacture.

### BACKGROUND

By way of background, individuals love to drive vehicles, however, learning to drive can be a challenging experience for many individuals. Inexperienced drivers may be prone to making mistakes that can lead to accidents and injuries, which can be a cause of concern for parents and other motorists. For learning to drive, finding a qualified and experienced driving instructor can be a challenge for individuals, especially in remote areas or areas with a limited number of instructors. The cost of driving lessons can be expensive, and some individuals may struggle to afford them. The cost of taking the driving test can also be a significant financial burden for many individuals.

Many parents want to teach their children driving, however, some parents may lack the time or patience to teach their children all aspects of safe driving, which can further compound the issue. Trainers and parents may not be physically available or present which leads to inadequate training of new drivers. Further, the absence of trainers and parents with new drivers can lead to accidents which is dangerous for all. Individuals need accessible and cost-effective driver training solutions that can help new drivers learn safe driving practices, build confidence, and minimize the risk of accidents and injuries on the road.

Therefore, there exists a long felt need in the art for an improved driver training system. There is also a long felt need in the art for a driver training system that enables trainers and parents to train new drivers even remotely. Additionally, there is a long felt need in the art for a driver training system that can be integrated into a vehicle for automatically operating the vehicle. Moreover, there is a long felt need in the art for a modified vehicle used to train new drivers and helps to reduce accidents. Further, there is a long felt need in the art of an improved vehicle that features autonomous driving functions that can take over the vehicle and perform optimal and safe maneuvers if the current driver is struggling with roadway safety. Finally, there is a long felt need in the art for a system that offers a way to teach and train inexperienced drivers through several different objectives in an easy and cost-effective manner.

The subject matter disclosed and claimed herein, in one embodiment thereof, comprises a multifunctional auto bot driving test vehicle system (ABDT system). The system features a processor, a display screen, the display screen configured to display instructions and training parameters to the driver, a plurality of cameras for capturing and recording video of inside the vehicle and the road, one or more speakers positioned inside the vehicle and configured to provide audio instructions in a desired language to the driver, a wireless channel established between a remote handheld device and a wireless transceiver of the ABDT system for pairing and communication, enabling a remote user to monitor the vehicle and provide feedback on areas for improvement through a mobile application installed on the remote handheld device. The ABDT system controls brakes, steering, movement, and other functionalities of the vehicle by sending instructions to the Electronic Control Unit (ECU) of the vehicle.

In this manner, the multifunctional auto bot driving test vehicle system of the present invention accomplishes all of the forgoing objectives and provides users with a system that can be integrated in a vehicle. The vehicle improves roadway safety by utilizing several technological features like cameras, auto-stop, auto-steer, and the like, in order to assist and educate the driver. The vehicle and the system allow parents and instructors to view videos from internal cameras via a mobile application to give instructions on how the driver should operate the vehicle.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a multifunctional auto bot driving test vehicle system (ABDT system). The ABDT system can be integrated into an ABDT vehicle during manufacturing or retrofitted to any existing vehicle. The ABDT system comprising an auto bot driving test processor, a display screen, a computer system, a plurality of cameras, and one or more speakers, the cameras are high-resolution image sensors with wide-angle lenses to capture video footage of the driver and surrounding vehicle. A mobile application is installed on a remote handheld device wherein the remote handheld device is paired with the system through a wireless channel wherein the ABDT system enables a remote user to monitor the vehicle through the mobile application. The remote user can view a recording captured by the cameras for monitoring driving of a driver and can provide audio commands which are played using the speakers.

In yet another embodiment, a multifunctional auto bot driving test vehicle system (ABDT system) designed for training new drivers and improving roadway safety is disclosed. The system further comprising an auto bot driving test processor controlling and executing the functions of the ABDT system, a display screen and the auto bot driving test processor forming a computer system integrated in the vehicle, with the display interface configured to display instructions and training parameters to the driver, a plurality of cameras for capturing and recording video of inside the vehicle and outside on the road, one or more speakers positioned inside the vehicle and configured to provide audio instructions in a desired language to the driver, a wireless channel established between a remote handheld device and a wireless transceiver of the ABDT system for pairing and communication, enabling a remote user to monitor the vehicle and provide feedback on areas for improvement through a mobile application installed on the remote handheld device wherein the ABDT system being configured to control brakes, steering, movement, and other functionalities of the vehicle by sending instructions to the Electronic Control Unit (ECU) of the vehicle, with the processor being coupled to the ECU through a Controller Area Network (CAN) enabling the processor to send and receive signals from the ECU.

In yet another embodiment, the auto bot driving test processor is configured to interpret instructions received from the mobile application installed in the remote handheld device via a wireless channel and send corresponding signals to an ECU to automatically control one or more components of a vehicle, such as the brakes, steering wheel, headlights and more, thereby enabling assistance for a driver and reducing accidents to improve roadway safety. The processor also monitors different parameters of the vehicle, such as speed and turning angle, and sends an auto-stop instruction to the ECU in case a critical condition is determined, without impacting other functionalities of the vehicle.

In a further embodiment, a method for training drivers for driving vehicles is disclosed. The method comprising the steps of creating a unique profile for each driver, tracking, and storing performance parameters of each driver in a database, determining the training level of the drivers based on the tracked parameters, and automatically transmitting a report to examiners when a driver's training level is sufficient to pass a road test to obtain a driver's license. The system further provides recommendations including additional safety tests and best practices to drivers whose training level is determined to be not enough for a driver's license.

In yet another embodiment, the system captures and records video footage of the road and driver using the plurality of high-resolution cameras and stores the recorded videos in a cloud-based storage service. The system also enables the remote user to monitor the vehicle and provide feedback on areas for improvement using a mobile application installed on the remote handheld device paired with the system through the wireless channel.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a functional block diagram of one potential embodiment of an auto bot driving test (ABDT) vehicle system of the present invention in accordance with the disclosed architecture;

FIG. 2 illustrates a functional block diagram showing autonomous control of steering wheel, brakes, headlights, and other components of the vehicle in which the ABDT system is installed in accordance with the disclosed architecture;

FIG. 3 illustrates a functional block diagram depicting access of information stored in cloud-based storage of the driver training system in accordance with the disclosed architecture;

FIG. 4 illustrates a flow diagram showing a process of determining training levels of a driver driving the vehicle with integrated ABDT system in accordance with the disclosed architecture;

FIG. 5 illustrates an exemplary user interface displaying a plurality of profiles registered in the auto bot driving test system installed in a vehicle in accordance with the disclosed architecture;

FIG. 6 illustrates a user interface showing profile of a driver including the completed safety tasks on the display screen in accordance with the disclosed architecture;

FIG. 7 illustrates an exemplary user interface displayed by the mobile application installed in the remote handheld device for enabling parents to monitor and control the driving of the vehicle by a driver in accordance with the disclosed architecture;

FIG. 8 illustrates a flow diagram depicting a process of authorizing remote users to control and monitor the driving of drivers driving the vehicle with installed system in accordance with the disclosed architecture;

FIG. 9 illustrates a flow diagram depicting a process of controlling the operation of the vehicle by installed ABDT system in response to received commands from a remote user in accordance with the disclosed architecture;

FIG. 10 illustrates another flow diagram depicting a process of controlling the operation of the vehicle by installed ABDT system in accordance with the disclosed architecture;

FIG. 11 illustrates a perspective view of an ABDT vehicle with integrated driver training system in accordance with the disclosed architecture; and

FIG. 12 illustrates a remote user viewing live video of a driver driving the ABDT vehicle via the application for controlling and monitoring in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for an improved driver training system. There is also a long felt need in the art for a driver training system that enables trainers and parents to train new drivers remotely. Additionally, there is a long felt need in the art for a driver training system that can be integrated into a vehicle for automatically operating the vehicle. Moreover, there is a long felt need in the art for a modified vehicle used to train new drivers and helps to reduce accidents. Further, there is a long felt need in the art of an improved vehicle that features autonomous driving functions that can take over the vehicle and perform optimal and safe maneuvers if the current driver is struggling with roadway safety. Finally, there is a long felt need in the art for a system that offers a way to teach and train inexperienced drivers through several different objectives in an easy and cost-effective manner.

The present invention, in one exemplary embodiment, is a vehicle for providing an integrated and advanced training platform for new drivers. The vehicle comprises an auto bot driving test processor, a display screen, cameras, speakers, a wireless channel, and electronic control unit (ECU) that can control brakes, steering, movement, and other functionalities of the vehicle. The vehicle enables remote monitoring and feedback by a remote user through the wireless channel and CAN network, reducing the need for in-person trainers and making it more accessible to individuals living in remote areas. The system improves roadway safety by controlling the vehicle's functionalities through instructions sent to the ECU by the processor.

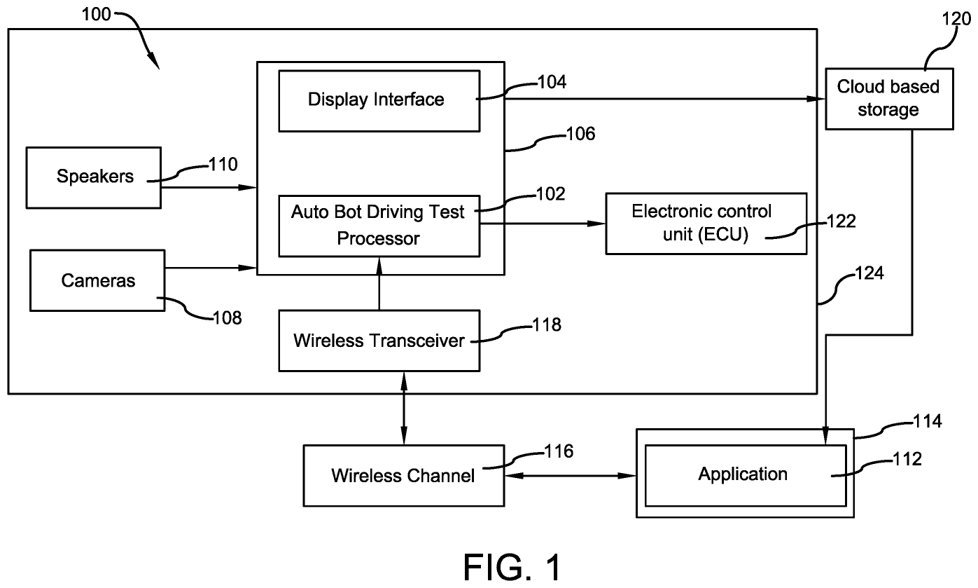

Referring initially to the drawings, FIG. 1 illustrates a functional block diagram of one potential embodiment of an auto bot driving test (ABDT) vehicle system of the present invention in accordance with the disclosed architecture. The auto bot driving test vehicle system 100 of the present invention is designed as a multifunctional training automobile system for new drivers. The test vehicle 100 is used for training new drivers and helps to reduce accidents, thus improving roadway safety. Further, the vehicle system 100 features autonomous driving functions that can take over the vehicle and perform optimal and safe maneuvers in case the current driver struggles with roadway safety. The vehicle system 100 can be integrated to an ABDT vehicle during manufacturing of the ABDT vehicle 124 or alternatively, can be retrofitted to any existing vehicle for converting the vehicle into the auto bot driving test (ABDT) vehicle.

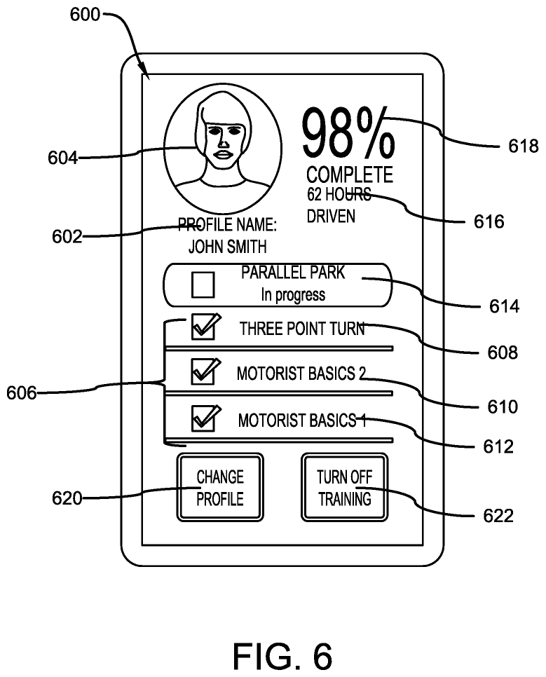

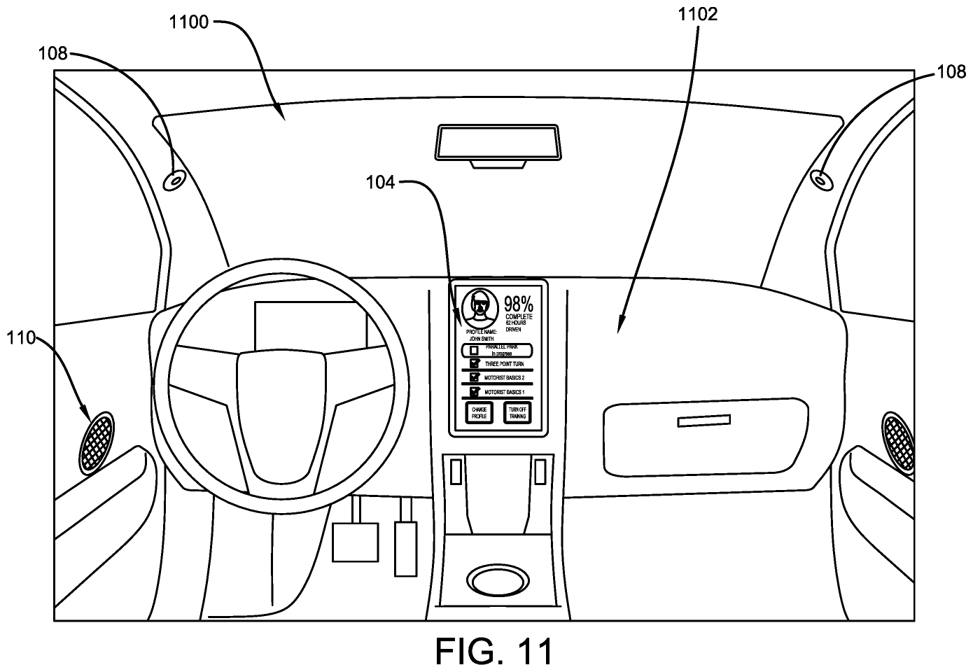

The auto bot driving test vehicle system 100 includes an auto bot driving test processor 102 which controls and executes functions of the system 100. A display screen or interface 104 together with the processor 102 forms a computer system 106 which is integrated in the vehicle. The display interface 104 is configured to display instructions and training parameters to a driver as illustrated in FIG. 6. The system 100 includes a plurality of cameras 108 for capturing and recording video inside the vehicle in which the system 100 is installed. Cameras 108 are configured to provide clear and reliable video footage of the road and the driver as described in FIG. 11. Preferably, the cameras 108 are high-resolution image sensors, such as 4K or higher, and have wide-angle lenses to capture a broad view of the road (i.e., outside the vehicle) and the driver (i.e., inside the vehicle). Further, the cameras 108 provide a high frame rate to ensure smooth and clear video footage.

For providing audio instructions to a driver driving the vehicle 124, one or more speakers 110 are included in the system 100 and positioned inside the vehicle. The speakers 110 are configured to provide an audio message in a desired language wherein the audio message can be automatic based on driving conditions as determined by the processor 102. Also, in some conditions, audio messages from the speakers 110 are sent by a remote user using the mobile application 112 installed in the remote handheld device 114.

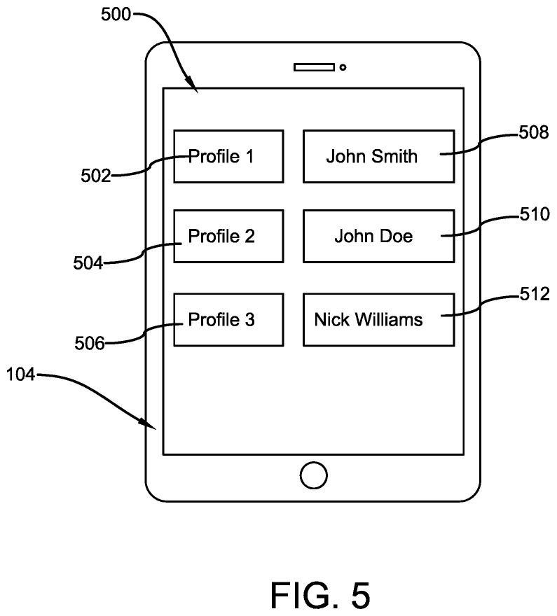

The system 100 enables a remote user such as a parent, care taker, or driving instructor to monitor the vehicle 124 installed with the system 100 when being driven by a new driver. More specifically, the mobile application 112 is installed in a handheld device 114 such as a smartphone, enabling the remote user to monitor and further control operation of the vehicle as described in FIGS. 5, 9, and 12. The remote handheld device 114 is paired with the system 100 enabling a remote user to monitor the vehicle. Specifically, using system 100, the application 112 enables parents to monitor their child's driving and provide feedback on areas for improvement. For pairing and communication between the application 112 and the system 100, a wireless channel 116 is used which is established between the remote handheld device 114 and a wireless transceiver 118 of the system 100. The wireless channel 116 can be a Wi-Fi channel used to transmit video data from the cameras 108 in the ABDT system 100 to the mobile device 114 or cloud-based storage service 120 for analysis and monitoring by parents or instructors. Additionally, the wireless channel 116 can also be any cellular data network, Bluetooth, or any other conventional wireless channel known in the state of the art.

The processor 102 of the ABDT system 100 is coupled to the Electronic Control Unit (ECU) 122 of the vehicle 124 for enabling the processor 102 to send instructions to the ECU 122 enabling autonomous control of different functionalities of the vehicle 124. In different embodiments of the present invention, the system 100 is configured to control brakes, steering, movement and other functionalities of the vehicle 124. The processor 102 and the ECU 122 are internally coupled through Controller Area Network (CAN) (not shown) enabling the processor 102 to send and receive signals from the ECU 122. In different embodiments, the processor 102 can be programmed to send commands to the ECU 122, for example, to apply the brakes if the ABDT system 100 detects that the driver is approaching an obstacle or based on receiving an instruction from the remote-control device 114.

The cloud-based storage 120 can be subscription based and is used for securely storing videos recorded by the cameras 108. The recorded videos can be accessed through the application 112 by remote users for monitoring. Further, the cloud-based storage 120 is also configured to store profile information of drivers driving the vehicle 124 as described in FIG. 5. The cloud-based storage 120 is configured to provide high availability, encryption, and disaster recovery.

The display screen or interface 104 has a high resolution to ensure that the information displayed is clear and easy to read and further, can be a touchscreen for enabling drivers to interact with the ABDT system 100 using touch gestures. The display device 104 is designed for easy mounting in the dashboard of the vehicle as illustrated in FIG. 11. The processor 102 can be a system-on-a-chip, microcontroller, single-board computer, field-programmable gate array, or any other processor. Also, the specific type of processor 102 used in the vehicle system 100 can depend on the specific requirements of the system 100 and the resources available to implement it.

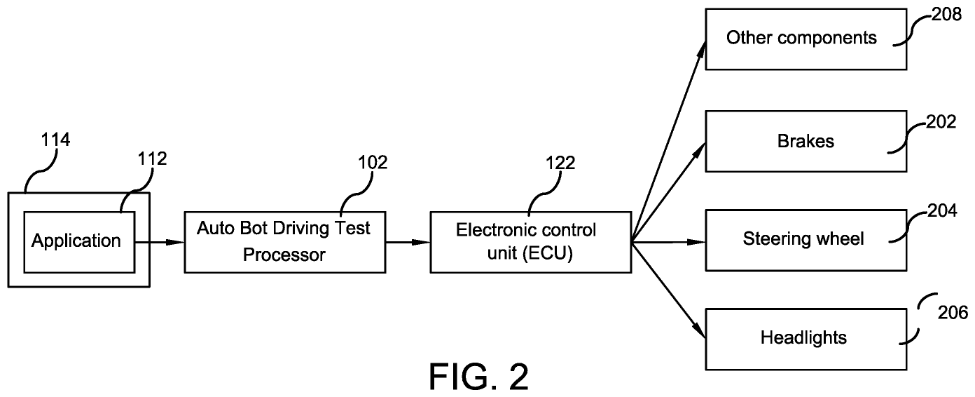

FIG. 2 illustrates a functional block diagram showing autonomous control of steering wheel, brakes, headlights, and other components of the vehicle in which the ABDT system 100 is installed in accordance with the disclosed architecture. The driving test system 100 provides automatic or autonomous stopping and steering functions of the vehicle enabling assistance to a driver, reducing accidents, and improving roadway safety. More specifically, the auto bot driving test processor 102 receives an instruction from the mobile application 112 installed in the remote handheld device 114 via the wireless channel 116 as illustrated in FIG. 1. The processor 102 is configured to interpret the instruction and send a corresponding signal to the ECU 122 enabling the ECU 122 to automatically control one or more of the brakes 202, steering wheel 204, headlights 206, and one or more of the other components 208 of the vehicle.

In some embodiments of the present invention, the processor 102 monitors different parameters such as speed, turning angle, and more of the vehicle and in case a critical condition is determined of the vehicle, an instruction signal is automatically transmitted to the ECU 122. For example, using the cameras 108, if the processor 102 determines that an obstacle is in front of the vehicle, then, an auto-stop instruction is sent to the ECU 122 for automatically applying brakes 202. It should be noted that communication between the processor 102 and the ECU 122 does not impact other functionalities of vehicle 124.

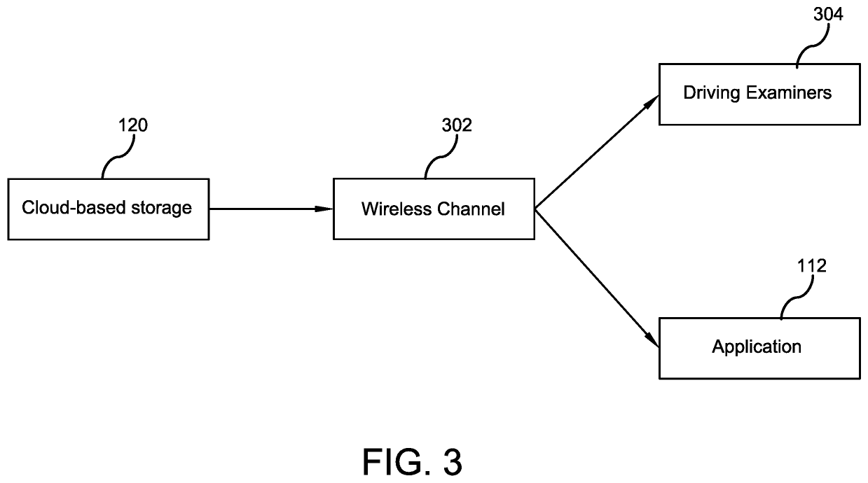

FIG. 3 illustrates a functional block diagram depicting access of information stored in cloud-based storage of the driver training system 100 in accordance with the disclosed architecture. An advantage of the system 100 of the present invention is that it can provide a driver's digital report to driver's license examiners and instructors 304 wirelessly using the wireless channel 302. The ABDT system 100 can provide a report to show when a new driver is able to pass a road test to obtain a driver's license. The report can include different data points on the driver's performance and progress, which can be used by driver's license examiners and instructors 304 to assess the driver's readiness for the road test as described in FIG. 6.

Video recording stored in the cloud storage 120 can also be accessed by remote users using the application 112. The video recordings are useful for providing instructions to the drivers learning to drive a vehicle using the vehicle driver training system 100. It should be noted that only users which are authorized to view recordings of specific drivers are provided access to the recorded videos. In one exemplary embodiment of the present invention, real-time videos captured by the cameras 108 are transmitted to the application 112 enabling parents to give instructions on how the driver should operate the vehicle.

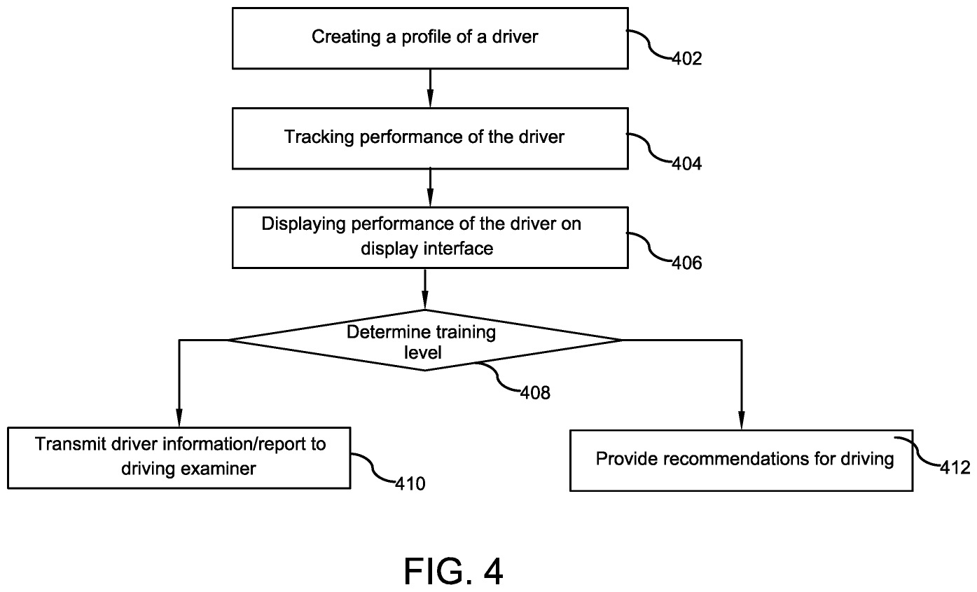

FIG. 4 illustrates a flow diagram showing a process of determining training levels of a driver driving the vehicle with integrated ABDT system 100 in accordance with the disclosed architecture. Initially, for training a driver for driving vehicles using the system 100, a profile of each driver is created (Step 402). The vehicle with installed system can be used by a plurality of drivers for training and learning purposes and a unique profile containing personal information is created for each driver. Before using the vehicle and the system, a profile is selected by a driver for tracking and logging purposes. After creation of the profile, performance of the driver whose profile is selected is tracked during driving of the vehicle (Step 404). Different parameters such as hours driven, driving tasks, and more are tracked and stored in the cloud-storage database 120 and in an internal memory of the display device 104 as well. The tracked performance parameters are also displayed on the display device 104 enabling the driver to view the parameters easily and to adjust accordingly (Step 406).

The ABDT system 100 based on the tracked parameters determines the training level of the driver driving the vehicle (Step 408). If the training level is determined to be sufficient to pass a road test to obtain a driver's license, then the report is automatically transmitted to driving examiners (Step 410). The report is transmitted via the cloud-based storage 120 as illustrated in FIG. 3. If the training level is determined to be not enough for a driver's license, then recommendations including additional safety tests, best practices, and more are displayed to the driver (Step 412).

FIG. 5 illustrates an exemplary user interface displaying a plurality of profiles registered in the auto bot driving test system installed in a vehicle in accordance with the disclosed architecture. As described earlier, a plurality of drivers can drive the vehicle 124 with installed system 100 for training and learning driving skills easily. For using the system 100 and driving the vehicle with installed system 100, a profile of the driver is created and selected for tracking purposes. As illustrated, a plurality of profiles 502, 504, 506 are displayed on the user interface 500. Preferably, names 508, 510, 512 are displayed and additional information including but not limited to age, photograph, and more can also be displayed on the user interface 500.

FIG. 6 illustrates a user interface showing profile of a driver including the completed safety tasks on the display screen or interface 104 in accordance with the disclosed architecture. As illustrated, the user interface 600 displays profile of a driver “John Smith” and displays image 604 of the driver 602. The interface 600 displays a list of completed safety tasks 606 shown exemplary as three point turn 608, motorist basics2 610 and motorist basics1 612. The ongoing safety task 614 that the driver 602 is in progress is displayed separately, enabling the driver 602 and the remote user monitoring the system 100 using the application 112 to view the ongoing safety task.

The interface 600 also displays logged driving hours 616 and training level 618 used for providing a report to driving examiners. A profile of a different driver can be selected by using the “Change Profile” icon 620 and in case a trained driver wants to drive the vehicle or a driver wants to turn off the training, then, the training can be turned off using the “Turn off training” icon 622.

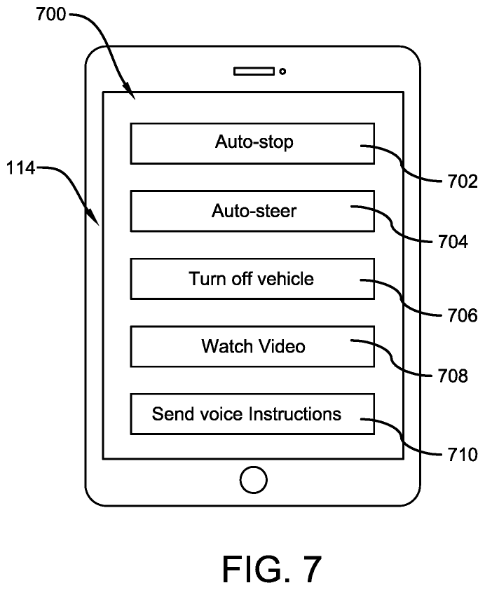

FIG. 7 illustrates an exemplary user interface displayed by the mobile application 112 installed in the remote handheld device 114 for enabling parents to monitor and control the driving of the vehicle by a driver in accordance with the disclosed architecture. The remote control device 114 is paired with the system 100 and enables a remote user such as a parent to remotely control the vehicle being driven by a driver using the application 112. The user interface 700 provides a plurality of options for controlling the vehicle remotely and includes an “Auto-stop” option 702 which upon selection instructs the system 100 to automatically apply the brakes of the vehicle. This can help prevent accidents and teach new drivers how to respond to unexpected situations on the road. An “Auto-steer” option 704 is provided to help the vehicle stay in its lane by automatically adjusting the steering. This can help new drivers learn to stay in their lane and avoid drifting into other lanes or off the road. A remote user can remotely turn off the vehicle for power saving using the “Turn off vehicle” option 706.

For watching live videos or recorded videos captured by the cameras 108, “Watch Video” option 708 can be selected by the remote user. This enables remote users to view driving of the vehicle and provide feedback and recommendations while controlling the movement of the vehicle. The application 112 enables remote users to provide voice messages to the driver driving the vehicle with installed system 100 using the “Send voice instructions” option 710. The voice messages are played out by the speakers 110 positioned inside the vehicle.

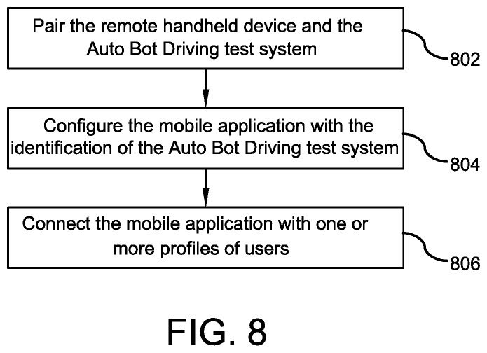

FIG. 8 illustrates a flow diagram depicting a process of authorizing remote users to control and monitor the driving of drivers driving the vehicle with installed system 100 in accordance with the disclosed architecture. Initially, the remote handheld device 114 and the ABDT system 100 is paired using the wireless channel 116 (Step 802). A plurality of separate handheld devices can be paired with the system 100 enabling a plurality of remote users to monitor and control driving of the vehicle. Then, the mobile application 112 is configured with an identification number or any other identity of the ABDT system (Step 804). In cases, where the system 100 is integrated inside the vehicle, the identification of the vehicle can be used for configuration of the mobile application for the system. Finally, as per preferences of the users, one or more profiles are connected with the mobile application 112 enabling remote users to control driving of only coupled and authorized drivers (Step 806).

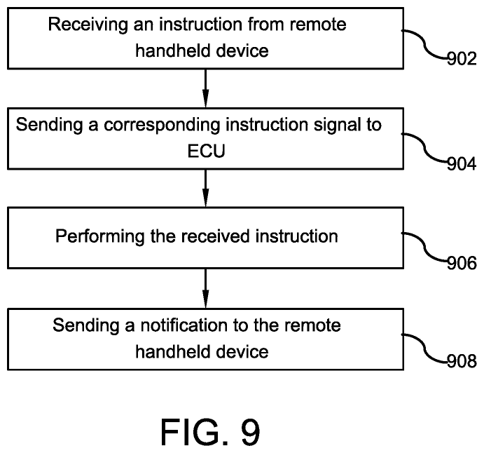

FIG. 9 illustrates a flow diagram depicting a process of controlling the operation of the vehicle by installed ABDT system 100 in response to received commands from a remote user in accordance with the disclosed architecture. Initially, ABDT system 100 receives an instruction from the remote handheld device 114, which could be a smartphone or tablet that is paired with the ABDT system 100 via the wireless connection (Step 902). Once the ABDT system 100 receives the instruction from the remote handheld device 114, the processor 102 sends a corresponding instruction signal to the vehicle's electronic control unit (ECU) 122, which controls the vehicle's brakes, steering, and other systems (Step 904). After receiving the instruction signal from the ABDT system, the ECU 122 performs the corresponding action (Step 906). In one embodiment of the present invention, the processor 102 without requiring the ECU 122 can directly control different components such as the vehicle's brakes, steering, and other systems. Finally, the ABDT system 100 sends a notification back to the remote handheld device 114 to inform the parent or instructor that the action has been performed. The notification can be in the form of a visual or auditory alert, or a message displayed on the application 112.

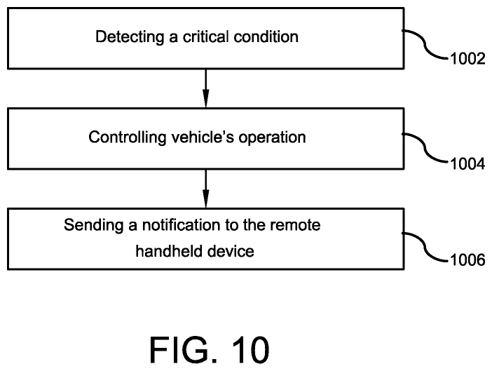

FIG. 10 illustrates another flow diagram depicting a process of controlling the operation of the vehicle by installed ABDT system 100 in accordance with the disclosed architecture. In the present embodiment, initially, the ABDT system 100 uses various sensors such as cameras, radar, and other detection devices to monitor the vehicle's surroundings and detect critical conditions such as obstacles in the road, sudden changes in traffic patterns, or driver errors (Step 1002). Upon detecting a critical condition, the system 100 controls the operation of the vehicle such as by automatically applying brakes, controlling steering, and more (Step 1004). Finally, a notification of an action performed and a detected critical condition is also transmitted to the application 112 installed in the remote electronic device 114 (Step 1006).

FIG. 11 illustrates a perspective view of an ABDT vehicle with integrated driver training system 100 in accordance with the disclosed architecture. The ABDT vehicle 1100 is a pictorial representation of the ABDT vehicle 124 shown in FIG. 1 and includes the cameras 108 positioned to capture the interior of the vehicle 1100. The cameras 108 are also configured to capture nearby surroundings of the vehicle 100 to detect any obstacles. The display device 104 is mounted on the dashboard 1102 for easy accessibility and viewing by a driver of the vehicle 1100. One or more speakers 110 are used for playing out audio messages inside the vehicle 1100 for giving instructions to the driver. As described earlier, the system 100 can be integrated into the vehicle 1100 during manufacturing of the vehicle or can be retrofitted as an aftermarket product.

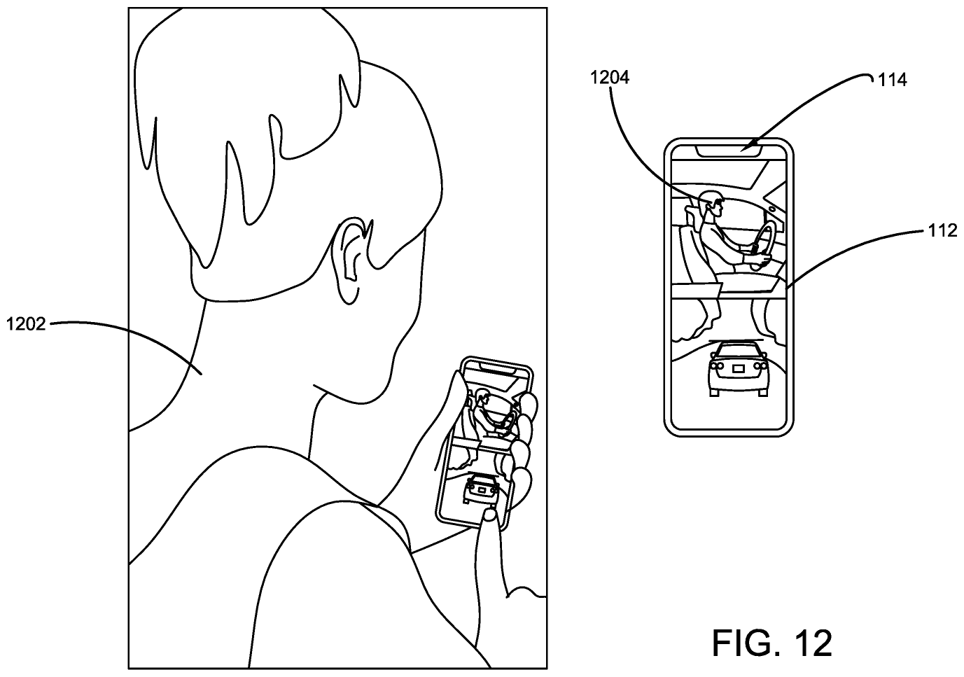

FIG. 12 illustrates a remote user viewing live video of a driver driving the vehicle 1100 via the application 112 for controlling and monitoring in accordance with the disclosed architecture. As illustrated, the remote user 1202 can view the live video 1204 from the ABDT system 100 through the paired mobile application 112. The ABDT vehicle 1100 is equipped with the cameras 108 that capture live video footage of the vehicle's interior and surroundings. The recordings are transmitted wirelessly to the paired mobile application 112, which is installed on a smartphone or tablet 114. The paired mobile application 112 can also offer additional features such as the ability to record and store video footage for later review.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ABDT system”, “auto bot driving test (ABDT) vehicle system”, “vehicle system”, “driver training system”, and “system” are interchangeable and refer to the auto bot driving test system 100 of the present invention. Similarly, as used herein “ABDT vehicle”, “auto bot driving test (ABDT) vehicle”, and “vehicle” are interchangeable and refer to the auto bot driving test vehicle 124, 1100 of the present invention.

Notwithstanding the forgoing, the auto bot driving test system 100 and the auto bot driving test vehicle 124, 1100 of the present invention can be of any suitable size and configuration as is known in the art without affecting the overall concept of the invention, provided that it accomplishes the above stated objectives. One of ordinary skill in the art will appreciate that the auto bot driving test system 100 and the auto bot driving test vehicle 124, 1100 as shown in the FIGS. are for illustrative purposes only, and that many other sizes and shapes of the auto bot driving test system 100 and the auto bot driving test vehicle 124, 1100 are well within the scope of the present disclosure. Although the dimensions of the auto bot driving test system 100 and the auto bot driving test vehicle 124, 1100 are important design parameters for user convenience, the auto bot driving test system 100 and the auto bot driving test vehicle 124, 1100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An auto bot driving test vehicle system comprising:
a driving test vehicle system having autonomous driving functions;
wherein said driving test vehicle system including an auto bot driving test (ABDT) vehicle;
wherein said autonomous driving functions having an auto bot driving test processor for controlling and executing functions of said driving test vehicle system, a display interface, an integrated computer system, a plurality of cameras, and at least one speaker in said ABDT vehicle;
wherein said display interface configured to display instructions and training parameters to a driver of said ABDT vehicle;
wherein said plurality of cameras for capturing and recording video inside said ABDT vehicle and outside said ABDT vehicle;
wherein said plurality of cameras capture and record at least the driver, and at least the road and surrounding areas near said ABDT vehicle;
wherein said at least one speaker for receiving audio instructions from a remote user to the driver;
a wireless transceiver for connecting said remote user to said autonomous driving functions and to the driver;
wherein said remote user monitors said autonomous driving functions;
wherein said remote user selectively provides feedback to the driver; and
a mobile application installed in a remote handheld device for connecting said remote user to the driver.

2. The auto bot driving test vehicle system of claim 1, wherein said remote user selectively controls said autonomous driving functions.

3. The auto bot driving test vehicle system of claim 1, wherein said wireless transceiver connecting said remote handheld device of said remote user having a wireless channel.

4. The auto bot driving test vehicle system of claim 3, wherein said wireless channel having a Wi-Fi channel for transmitting video data from said plurality of cameras in said ABDT vehicle to said mobile device.

5. The auto bot driving test vehicle system of claim 3, wherein said wireless channel selected from a group consisting of a cellular data network and a Bluetooth.

6. The auto bot driving test vehicle system of claim 1, wherein said plurality of cameras for capturing and recording video inside and outside said ABDT vehicle include wide-angle lenses.

7. The auto bot driving test vehicle system of claim 1, wherein said remote user selected from a group consisting of a parent, a care taker, and a driving instructor.

8. The auto bot driving test vehicle system of claim 1, wherein said auto bot driving test processor coupled to an Electronic Control Unit (ECU) of said ABDT vehicle.

9. The auto bot driving test vehicle system of claim 8, wherein said auto bot driving test processor sends instructions to said ECU for autonomous control of different functionalities of said ABDT vehicle.

10. The auto bot driving test vehicle system of claim 9, wherein said autonomous driving functions selected from a group consisting of a braking, a steering, a lighting, and a movement of said ABDT vehicle.

11. The auto bot driving test vehicle system of claim 10, wherein said auto bot driving test processor receives an instruction from said mobile application installed in said remote handheld device via said wireless channel.

12. The auto bot driving test vehicle system of claim 11, wherein said auto bot driving test processor interprets said instruction and sends a corresponding signal to said ECU.

13. An auto bot driving test vehicle system comprising:
a driving test vehicle system having autonomous driving functions;
wherein said driving test vehicle system including an auto bot driving test (ABDT) vehicle;
wherein said autonomous driving functions having an auto bot driving test processor for controlling and executing functions of said driving test vehicle system, a display interface, an integrated computer system, a plurality of cameras, and at least one speaker in said ABDT vehicle;
wherein said display interface configured to display instructions and training parameters to a driver of said ABDT vehicle;
wherein said plurality of cameras for capturing and recording video inside said ABDT vehicle and outside said ABDT vehicle;
wherein said plurality of cameras capture and record at least the driver, and at least the road and surrounding areas near said ABDT vehicle;
wherein said at least one speaker for receiving audio instructions from a remote user to the driver;
a wireless transceiver for connecting said remote user to said autonomous driving functions and to the driver;
wherein said remote user monitors said autonomous driving functions;
wherein said remote user selectively provides feedback to the driver; and
further wherein said remote user selectively controls said autonomous driving functions.

14. The auto bot driving test vehicle system of claim 13 wherein said wireless transceiver connecting a remote handheld device and a mobile application of said remote user having a wireless channel, and further wherein said mobile application installed in said remote handheld device for connecting said remote user to the driver.

15. The auto bot driving test vehicle system of claim 14, wherein said wireless channel having a Wi-Fi channel for transmitting video data from said plurality of cameras in said ABDT vehicle to said mobile device.

16. The auto bot driving test vehicle system of claim 14, wherein said wireless channel selected from a group consisting of a cellular data network and a Bluetooth.

17. The auto bot driving test vehicle system of claim 13, wherein said auto bot driving test processor coupled to an Electronic Control Unit (ECU) of said ABDT vehicle wherein said remote user selectively controls said autonomous driving functions.

18. The auto bot driving test vehicle system of claim 17, wherein said autonomous driving functions selected from a group consisting of a braking, a steering, a lighting, and a movement of said ABDT vehicle.

19. The auto bot driving test vehicle system of claim 18, wherein said auto bot driving test processor interprets said instruction and sends a corresponding signal to said ECU.

20. An auto bot driving test vehicle system comprising:
a driving test vehicle system having autonomous driving functions;
wherein said driving test vehicle system including an auto bot driving test (ABDT) vehicle;
wherein said autonomous driving functions having an auto bot driving test processor for controlling and executing functions of said driving test vehicle system, a display interface, an integrated computer system, a plurality of cameras, and at least one speaker in said ABDT vehicle;
wherein said display interface configured to display instructions and training parameters to a driver of said ABDT vehicle;
wherein said plurality of cameras for capturing and recording video inside said ABDT vehicle and outside said ABDT vehicle;
wherein said plurality of cameras capture and record at least the driver, and at least the road and surrounding areas near said ABDT vehicle;
wherein said at least one speaker for receiving audio instructions from a remote user to the driver;
a wireless transceiver for connecting said remote user to said autonomous driving functions and to the driver;
wherein said remote user monitors said autonomous driving functions;
wherein said remote user selectively provides feedback to the driver;
wherein said remote user selectively controls said autonomous driving functions;
wherein said auto bot driving test processor coupled to an Electronic Control Unit (ECU) of said ABDT vehicle wherein said remote user selectively controls said autonomous driving functions; and
further wherein said autonomous driving functions selected from a group consisting of a braking, a steering, a lighting, and a movement of said ABDT vehicle.
